(19) United States
(12) Patent Application Publication
(10) Pub. No.: US 2025/0386121 A1
(43) Pub. Date: Dec. 18, 2025

(54) PHOTOELECTRIC CONVERSION APPARATUS, PHOTOELECTRIC CONVERSION SYSTEM, AND MOVING BODY

(71) Applicant: CANON KABUSHIKI KAISHA, Tokyo (JP)

(72) Inventors: DAIKI SHIRAHIGE, Kanagawa (JP); TAKAFUMI MIKI, Kanagawa (JP)

(21) Appl. No.: 19/232,225

(22) Filed: Jun. 9, 2025

(30) Foreign Application Priority Data
Jun. 13, 2024 (JP) 2024-095706

(51) Int. Cl. H04N 25/79; H04N 25/78

(52) U.S. Cl. CPC H04N 25/79; H04N 25/78

(57) ABSTRACT

A photoelectric conversion apparatus includes a substrate including, a first photoelectric conversion portion, a second photoelectric conversion portion, a first floating diffusion layer, and a second floating diffusion layer, a transfer transistor, and a plurality of wiring layers stacked on a surface of the substrate, wherein the photoelectric conversion apparatus includes first wiring connecting the first floating diffusion layer and the second floating diffusion layer to each other at a height between a height of the surface and a height of a wiring layer closest to the substrate of the plurality of wiring layers, and wherein a first distance between the surface and an upper surface of the first wiring is different from a second distance between the surface and an upper surface of a gate electrode of the transfer transistor.

### BACKGROUND

### Technical Field

The aspect of the embodiments relates to a photoelectric conversion apparatus, a photoelectric conversion system, and a moving body.

### Description of the Related Art

There has been a known photoelectric conversion apparatus that transfers electric charges photoelectrically converted by photodiodes to floating diffusions and amplifies the signals as voltage signals.

International Patent Publication No. WO 2016/199588 discusses a technique for reducing the parasitic capacitance of a floating diffusion using low-profile wiring for the connection from the floating diffusion to the gate of a source follower transistor or to the source of a reset transistor. However, a suitable configuration for layout of the wiring connected between floating diffusions is not taken into account.

### SUMMARY

According to an aspect of the embodiments, a photoelectric conversion apparatus includes a substrate including, a first photoelectric conversion portion, a second photoelectric conversion portion, a first floating diffusion layer to which an electric charge generated in the first photoelectric conversion portion is transferred, and a second floating diffusion layer to which an electric charge generated in the second photoelectric conversion portion is transferred, a transfer transistor configured to transfer the electric charge generated in the first photoelectric conversion portion to the first floating diffusion layer, and a plurality of wiring layers stacked on a surface of the substrate, wherein the photoelectric conversion apparatus includes first wiring connecting the first floating diffusion layer and the second floating diffusion layer to each other at a height between a height of the surface and a height of a wiring layer closest to the substrate of the plurality of wiring layers, and wherein a first distance between the surface and an upper surface of the first wiring is different from a second distance between the surface and an upper surface of a gate electrode of the transfer transistor.

Further features of the disclosure will become apparent from the following description of exemplary embodiments with reference to the attached drawings.

### BRIEF DESCRIPTION OF THE DRAWINGS

FIG. 1 is a block diagram illustrating a schematic configuration of a photoelectric conversion apparatus according to a first exemplary embodiment.

FIG. 2 is a diagram of an equivalent circuit of pixels according to the first exemplary embodiment.

FIGS. 3A and 3B are plan views each illustrating pixels according to the first exemplary embodiment.

FIG. 4 is a sectional view illustrating the pixels according to the first exemplary embodiment.

FIG. 5 is a sectional view illustrating the pixels according to the first exemplary embodiment.

FIG. 6 is a plan view illustrating pixels according to a second exemplary embodiment.

FIG. 7 is a plan view illustrating pixels according to a third exemplary embodiment.

FIG. 8 is a plan view illustrating pixels according to a fourth exemplary embodiment.

FIG. 9 is a plan view illustrating pixels according to the fourth exemplary embodiment.

FIG. 10 is a diagram of an equivalent circuit of pixels according to a fifth exemplary embodiment.

FIG. 11 is a plan view illustrating the pixels according to the fifth exemplary embodiment.

FIG. 12 is a plan view illustrating the pixels according to the fifth exemplary embodiment.

FIG. 13 is a diagram of an equivalent circuit of pixels according to a sixth exemplary embodiment.

FIG. 14 is a plan view illustrating pixels according to a seventh exemplary embodiment.

FIG. 15 is a sectional view illustrating the pixels according to the seventh exemplary embodiment.

FIG. 16 is a plan view illustrating pixels according to an eighth exemplary embodiment.

FIG. 17 is a plan view illustrating pixels according to a ninth exemplary embodiment.

FIG. 18A is a schematic diagram illustrating equipment according to a tenth exemplary embodiment. FIGS. 18B and 18C illustrate a photoelectric conversion system and a moving body according to the tenth exemplary embodiment.

### DESCRIPTION OF THE EMBODIMENTS

The following exemplary embodiments are intended to embody the technical idea of the present invention and do not limit the present invention. Some of the sizes and the positional relationships of members illustrated in the drawings are exaggerated for clarity of description. In the following description, the same components are denoted by the same reference numerals, and the descriptions thereof may be omitted.

Exemplary embodiments of the present invention will be described in detail below with reference to the drawings. In the following description, terms representing specific directions or positions (for example, “upper”, “lower”, “right”, “left”, and other terms including those terms) are used as necessary. These terms are used to facilitate understanding of the exemplary embodiments with reference to the drawings, and the meanings of the terms do not limit the technical scope of the present invention.

In this specification, a plan view corresponds to viewing a photoelectric conversion apparatus from a direction perpendicular to the light incident surface of a semiconductor layer. A sectional view corresponds to viewing a section perpendicular to the light incident surface of the semiconductor layer. If the light incident surface of the semiconductor layer is rough microscopically, the plan view is defined based on the light incident surface of the semiconductor layer when viewed macroscopically.

In the following exemplary embodiments, a connection between circuit elements may be described. In this case, even if another element is interposed between elements of interest, unless otherwise described, the elements of interest are considered to be connected. For example, it is on the assumption that an element A is connected to one node of a capacitor element C, which includes a plurality of nodes, and an element B is connected to the other node of the capacitor element C. Even in such a case, unless otherwise described, the element A and the element B are considered to be connected.

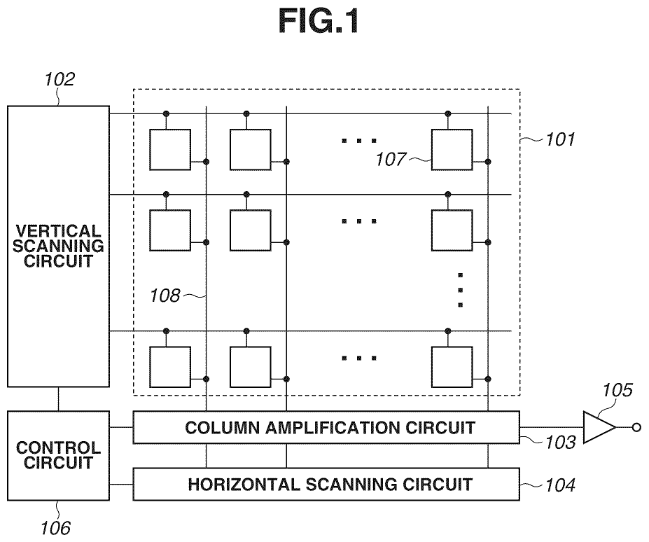

A first exemplary embodiment of the present invention will be described with reference to FIGS. 1 to 5.

FIG. 1 is a block diagram illustrating a schematic configuration of a photoelectric conversion apparatus according to the present exemplary embodiment. The photoelectric conversion apparatus includes a pixel array 101, a vertical scanning circuit 102, a column amplification circuit 103, a horizontal scanning circuit 104, an output circuit 105, and a control circuit 106. The photoelectric conversion apparatus is a semiconductor apparatus formed on a semiconductor substrate, such as a silicon substrate. In the present exemplary embodiment, the photoelectric conversion apparatus is a complementary metal-oxide semiconductor (CMOS) image sensor.

The pixel array 101 includes a plurality of pixels 107 arranged in a two-dimensional pattern with a plurality of rows and a plurality of columns on a semiconductor substrate.

The vertical scanning circuit 102 supplies a plurality of control signals for controlling a plurality of transistors included in the pixels 107 to be turned on (i.e., a conducting state) or off (i.e., a non-conducting state). In each column of the pixels 107, a column signal line 108 is provided, and signals from the pixels 107 are read to the column signal lines 108 on a per-column basis.

The column amplification circuit 103 amplifies the pixel signals output to the column signal lines 108 and performs processing, such as correlated double sampling processing based on reset signals and photoelectric conversion signals of the pixels 107.

The horizontal scanning circuit 104 includes switches connected to amplifiers of the column amplification circuit 103 and supplies control signals to control the switches to be turned on or off.

The output circuit 105 includes a buffer amplifier, a differential amplifier, and the like and outputs the pixel signals from the column amplification circuit 103 to a signal processing unit outside the photoelectric conversion apparatus.

The control circuit 106 controls the vertical scanning circuit 102, the column amplification circuit 103, and the horizontal scanning circuit 104.

Further, with an analog-to-digital (AD) conversion unit, the photoelectric conversion apparatus can be configured to output digital pixel signals. Various elements included in the photoelectric conversion apparatus can be separately disposed on a plurality of semiconductor substrates. For example, the pixel array 101 is disposed on a first substrate, and other elements are disposed on a second substrate, with the first substrate and the second substrate being stacked.

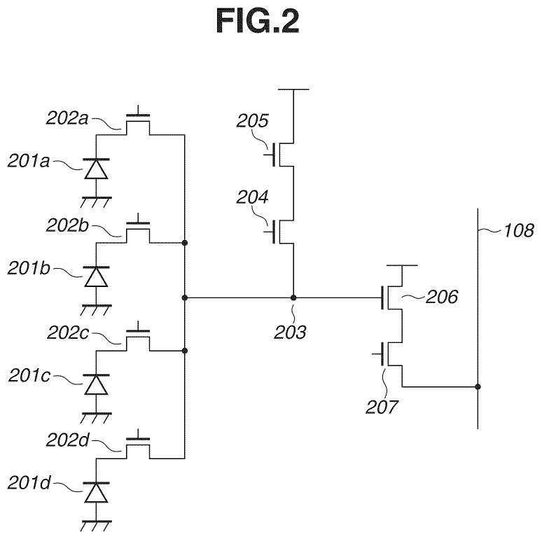

FIG. 2 is a diagram of an equivalent circuit of two pixels 107. One pixel 107 in the photoelectric conversion apparatus according to the present exemplary embodiment includes two photodiodes (PDs). The two pixels 107 share one floating diffusion (FD) (i.e., a floating diffusion layer), and four PDs 201 in the two pixels 107 share an FD 203.

A first photoelectric conversion portion PD 201a is connected to the FD 203 via a first transfer transistor TX 202a. A second photoelectric conversion portion PD 201b is connected to the FD 203 via a second transfer transistor TX 202b. A third photoelectric conversion portion PD 201c is connected to the FD 203 via a third transfer transistor TX 202c. A fourth photoelectric conversion portion PD 201d is connected to the FD 203 via a fourth transfer transistor TX 202d.

The FD 203 is connected to the source of a dual conversion gain transistor (DCG) 204, and the drain of the DCG 204 is connected to the source of a reset transistor (RES) 205. The drain of the RES 205 is connected to a power supply. The FD 203 is also connected to the gate of a source follower transistor (SF) 206, and the source of the SF 206 is connected to the drain of a select transistor (SEL) 207. The source of the SEL 207 is connected to the corresponding column signal line 108.

The PDs 201a to 201d (hereinafter also referred to as the “PD 201”) generate electric charges based on the amount of incident light. The generated electric charges are transferred to the FD 203 with the TXs 202a to 202d turned on. The FD 203 temporarily holds the electric charges transferred from the PD 201 and converts the signal electric charges into voltage signals. In this case, an electric charge-voltage conversion gain is determined depending on the capacitance of the FD 203. Switching on and off the DCG 204 connected to the FD 203 can change a capacitance value of the FD 203, which allows the electric charge-voltage conversion gain in the FD 203 to be controlled.

In this case, the source of the DCG 204 is connected to the FD 203. Alternatively, the DCG 204 may not be included and the source of the RES 205 can be connected to the FD 203. The RES 205 is used to discharge an electric charge accumulated in the FD 203 to the power supply to reset the electric charge accumulated in the FD 203. The gate potential of the SF 206 varies depending on the electric charge accumulated in the FD 203, and the source potential of the SF 206 varies accordingly. The source potential of the SF 206 is sequentially output to the corresponding column signal line 108 via the SEL 207, making it possible to output light incident on the PD 201 as electrical signals.

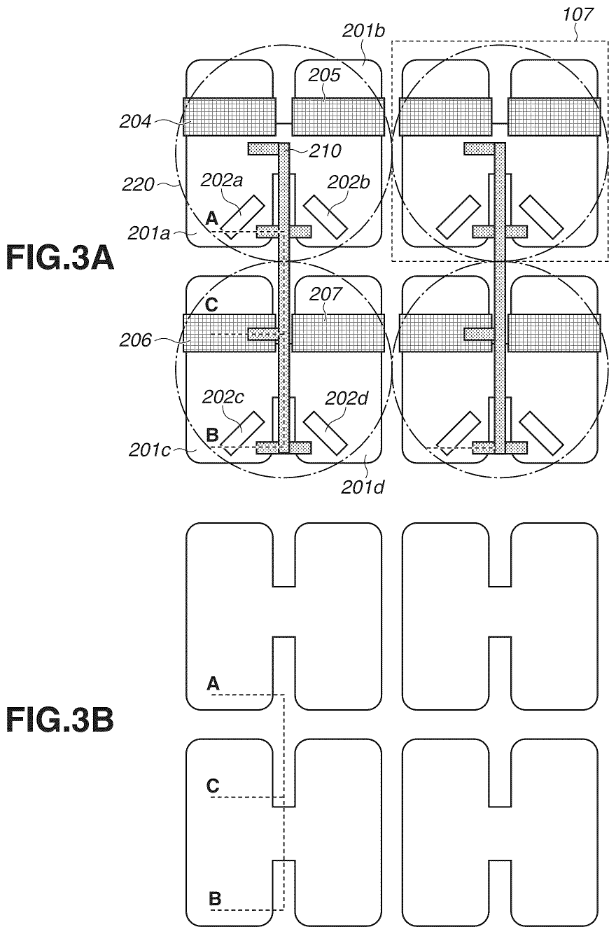

FIGS. 3A and 3B are plan views each illustrating the pixels 107 according to the present exemplary embodiment. FIG. 3A illustrates an arrangement example where FD wires 210 and pixel transistors are also arranged. FIG. 3B illustrates the semiconductor layer alone.

FIGS. 3A and 3B each illustrate four pixels 107 arranged in two rows and two columns. As illustrated in FIG. 2, each of the pixels 107 includes the DCG 204, the RES 205, the SF 206, and the SEL 207. Microlenses 220 and the pixels 107 are arranged in one-to-one correspondence, and each pixel 107 includes two PDs 201. In other words, two PDs 201 are disposed for a single microlens 220. The arrangement of a plurality of PDs 201 for a single microlens 220 makes it possible to obtain image capturing signals, as well as phase difference detection signals for autofocusing.

As illustrated in FIG. 3B, a single semiconductor layer is formed with the two PDs connected in the center of the single semiconductor. As illustrated in FIG. 3B, the left PD 201 in the upper-left first pixel 107 is referred to as the PD 201a, the right PD 201 in the upper-left first pixel 107 as the PD 201b, the left PD 201 in the lower-left second pixel 107 as the PD 201c, and the right PD 201 in the lower-right second pixel 107 as the PD 201d. In other words, two pixels in the vertical direction (the column direction) illustrated in FIG. 3B share the common FD 203 illustrated in the circuit diagram of FIG. 2.

As illustrated in FIG. 3A, the PD 201a is provided with the gate of the TX 202a, and the PD 201b is provided with the gate of the TX 202b. The PD 201c is provided with the gate of the TX 202c, and the PD 201d is provided with the gate of the TX 202d. As illustrated in FIG. 3A, the upper-left pixel 107 is provided with the DCG 204 and the gate of the RES 205. As illustrated in FIG. 3A, the lower-left pixel 107 is provided with the SF 206 and the gate of the SEL 207. The PDs 201a to 201d correspond to the sources of the TX 202a to the TX 202d, respectively. The drain of the TX 202a corresponds to a first floating diffusion layer, and the drain of the TX 202b corresponds to a second floating diffusion layer. The drain of the TX 202c corresponds to a third floating diffusion layer, and the drain of the TX 202d corresponds to a fourth floating diffusion layer. These floating diffusion layers are connected to a single FD wire 210 dedicated for the floating diffusion layers and are connected to the gate of the SF 206 and the source of the DCG 204 by the FD wire 210 to form one FD 203.

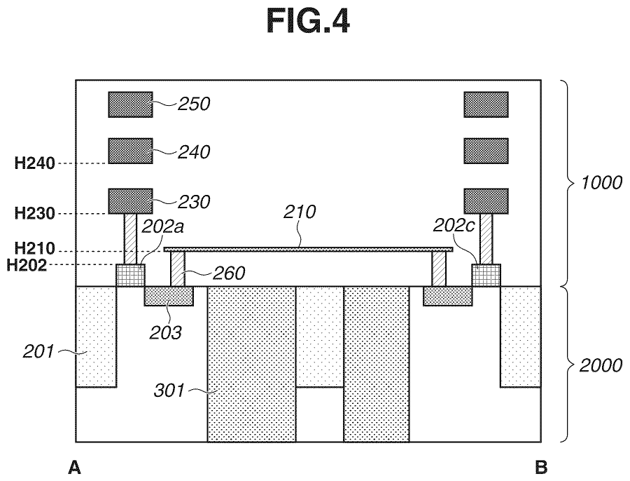

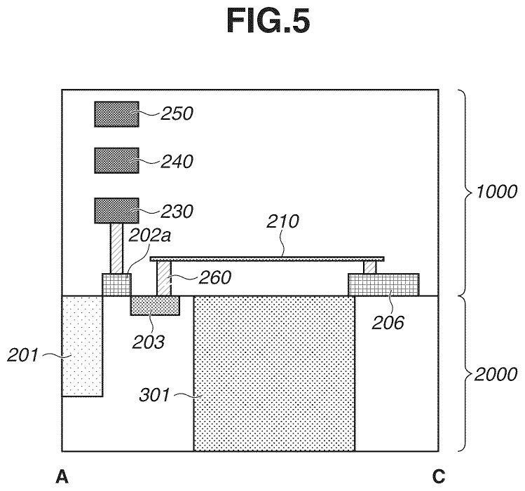

FIG. 4 is a sectional view taken along the dashed line A-B illustrated in FIGS. 3A and 3B, and FIG. 5 is a sectional view taken along the dashed line A-C illustrated in FIGS. 3A and 3B.

FIG. 4 is a sectional view illustrating the pixels 107 taken along the line A-B according to the present exemplary embodiment. A plurality of wiring layers of a wiring structure 1000 is stacked on a surface of a semiconductor substrate 2000. The wiring structure 1000 includes a first wiring layer 230, a second wiring layer 240, and a third wiring layer 250, all of which are formed in that order from the side closer to the semiconductor substrate 2000. In the wiring structure 1000, a plurality of wiring layers is disposed in an insulating layer. Specifically, an insulating layer is disposed between the first wiring layer 230 and the semiconductor substrate 2000, and insulating layers are disposed between the plurality of wiring layers. While FIG. 4 illustrates three wiring layers, the number of wiring layers is not limited to three. Four or more wiring layers, or two or less wiring layers can be disposed.

In the present exemplary embodiment, the FD wire 210 is disposed at a height between the height of the surface of the semiconductor substrate 2000 and the height of the first wiring layer 230 closest to the semiconductor substrate 2000 of the wiring layers. An insulating layer can be disposed between the FD wire 210 and the semiconductor substrate 2000. In this case, it is on the assumption that the height of the first wiring layer 230 refers to a height (H230) of the surface of the first wiring layer 230 closer to the semiconductor substrate 2000. Similarly, for the other wiring layers, the heights of the surfaces closer to the semiconductor substrate 2000 are considered to be the heights of the wiring layers.

The FD wire 210 is disposed at a height between the height of the first wiring layer 230 and the height (H202) of the gates of the transistors, such as TX 202a and TX 202c. The FD wire 210 and the FD 203 are connected via contact metals 260. The FD wire 210 is made shorter than the first wiring layer 230 and the second wiring layer 240. This configuration can reduce the parasitic capacitance induced by the wiring. Reduction in parasitic capacitance of the FD wire 210 leads to reduction in random telegraph signal (RTS) noise. Specifically, the height from the semiconductor substrate 2000 to the surface (H230) closer to the semiconductor substrate 2000 of the first wiring layer 230 is 0.6 μm, and the thickness of the first wiring layer 230 is 0.2 μm. The height from the semiconductor substrate 2000 to the surface (H240) closer to the semiconductor substrate 2000 of the second wiring layer 240 is 1.2 μm, and the thickness of the second wiring layer 240 is 0.2 μm. The height from the semiconductor substrate 2000 to the upper surface (H202) of the gate of the TX 202 is 0.2 μm. Further, the height from the semiconductor substrate 2000 to the surface (H210) closer to the semiconductor substrate 2000 of the FD wire 210 is 0.3 μm, and the thickness of the FD wiring 210 is 0.05 μm.

The FD wire 210 can be formed of, for example, titanium (Ti), titanium nitride (TiN), tungsten (W), aluminum (Al), or copper (Cu). The FD wire 210 can have a stacked structure of titanium and titanium nitride (Ti/TiN/Ti).

The PD 201a and the PD 201b, as well as each PD 201 and the adjacent pixels 107, are electrically isolated by an inter-pixel isolation portion 301. Similarly, the PDs 203 are each electrically isolated by the inter-pixel isolation portion 301. This purpose is to prevent mixture of signals.

The pixels 107 may be isolated by PN isolation or insulation isolation. Specifically, the inter-pixel isolation portion 301 can be included in a semiconductor layer having a different conductivity type from that of the semiconductor layer including the PD 201, or can have a trench structure formed in the semiconductor layer. A metal or an insulator may be embedded or may not be embedded in the trench structure. In the example illustrated in FIG. 4, the inter-pixel isolation portion 301 has a deep trench isolation (DTI) structure and penetrates through the semiconductor substrate 2000.

FIG. 5 is a sectional view illustrating the pixels 107 taken along the line A-C according to the present exemplary embodiment. The FD wire 210 connected to the FD 203 is connected to the gate of the SF 206 via the contact metals 260.

The wiring connecting between the FDs 203 is disposed to connect a plurality of PDs 201 included in a single pixel 107 or PDs 201 included in a plurality of pixels 107. Thus, it is difficult to dispose the wiring in the same layer as other wiring in terms of layout. In addition, the generation of capacitive coupling to the other wiring causes noise. In one embodiment, the FD wire 210 is disposed in a different layer from the other wiring.

In the photoelectric conversion apparatus according to the present exemplary embodiment, the FD wire 210 is disposed at a height between the height of the first wiring layer 230 and the height of the gates of the transistors. This reduces constraints on the layout of elements and wiring included in each pixel 107, enabling a more compact arrangement and avoiding capacitive coupling. Further, this provides the effect of reducing noise caused by wiring capacitance.

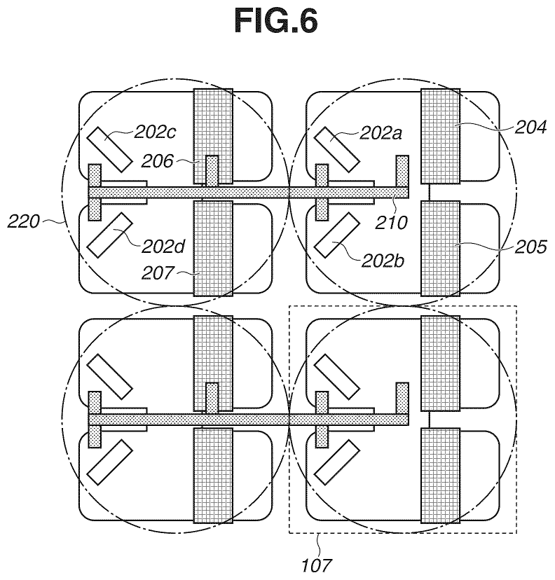

A photoelectric conversion apparatus according to a second exemplary embodiment will now be described with reference to FIG. 6. The difference from the first exemplary embodiment will be mainly described, and the redundant description will be omitted as appropriate. In the photoelectric conversion apparatus according to the present exemplary embodiment, the direction in which two PDs 201 are arranged in each pixel 107 is different from that of the photoelectric conversion apparatus according to the first exemplary embodiment. In the first exemplary embodiment, the two PDs 201 are arranged in a row direction with respect to one pixel 107. In the present exemplary embodiment, the two PDs 201 are arranged in a vertical direction with respect to one pixel 107.

The photoelectric conversion apparatus according to the first exemplary embodiment can easily perform autofocusing on an object with a vertical-striped contrast, but is difficult to perform autofocusing on an object with a horizontal-striped contrast. The PDs 201 in the photoelectric conversion apparatus according to the present exemplary embodiment are arranged to facilitate autofocusing on an object with a horizontal-striped contrast.

Thus, the change of the arrangement direction (the alignment direction) of the two PDs 201 relative to one microlens 220 makes it possible to form a configuration that facilitates autofocusing on an object with a contrast in an arbitrary direction. In the present exemplary embodiment, while the case is described where each PD 201 is vertically divided, each PD 201 can be disposed with a certain angle, for example, in an oblique direction.

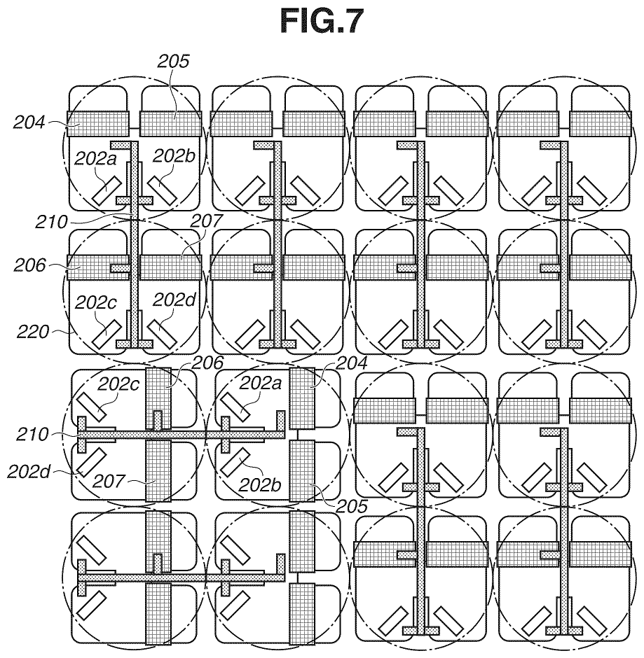

A photoelectric conversion apparatus according to a third exemplary embodiment will now be described with reference to FIG. 7. The difference from the first exemplary embodiment will be mainly described, and the redundant description of the same components will be omitted as appropriate. The present exemplary embodiment differs from the first exemplary embodiment in that two types of pixels 107 with different arrangement directions of the PDs 201 coexist in the pixel array 101.

Such an arrangement of the pixels 107 with different arrangement directions of the PDs 201 in the pixel array 101 enables high-accuracy autofocus on a wider variety of object patterns.

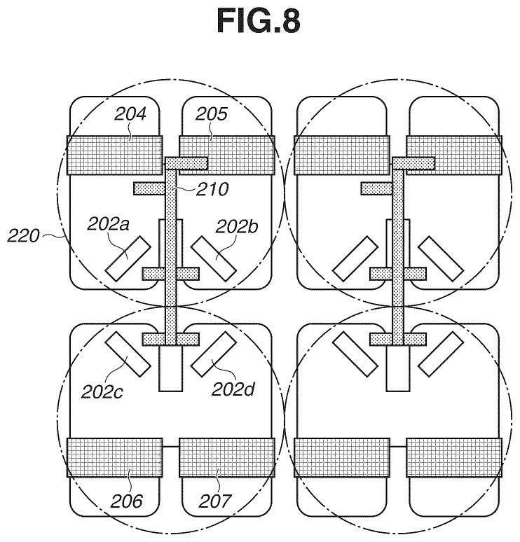

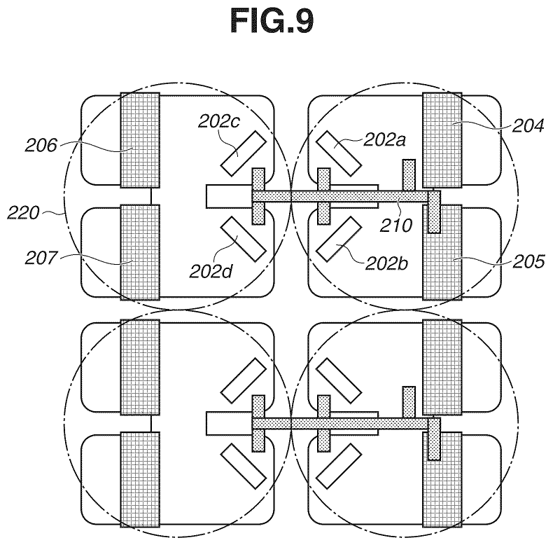

A photoelectric conversion apparatus according to a fourth exemplary embodiment will now be described with reference to FIGS. 8 and 9. The photoelectric conversion apparatus according to the present exemplary embodiment differs from the photoelectric conversion apparatus according to the first exemplary embodiment in that elements included in two pixels 107 sharing one FD 203 are disposed in a mirror arrangement symmetrical with respect to the FD 203. This arrangement makes it possible to shorten the FD wire 210 compared with the configuration described in the first exemplary embodiment, further reducing the parasitic capacitance of the FD 203.

FIG. 9 illustrates a modified example of the configuration illustrated in FIG. 8. In a mirror arrangement as illustrated in FIG. 9, the two PDs 201 in each pixel 107 can be vertically arranged. Similarly to the pixels 107 illustrated in FIGS. 8 and 9, the two types of pixels 107 with different arrangement directions of the PDs 201 can coexist in the pixel array 101. In this manner, changing the arrangement directions of the two PDs 201 included in one pixel 107 relative to the array direction of the pixels 107 facilitates autofocusing on an object with a contrast in an arbitrary direction.

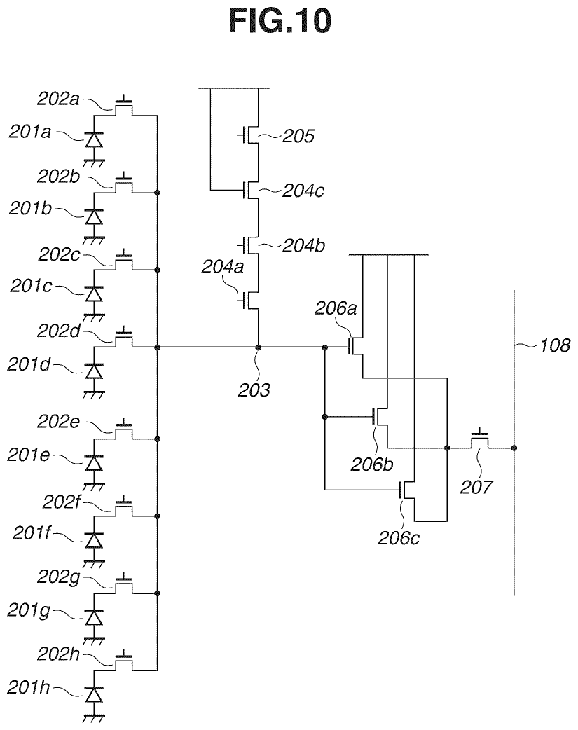

A photoelectric conversion apparatus according to a fifth exemplary embodiment will now be described with reference to FIGS. 10, 11, and 12. In the present exemplary embodiment, four pixels 107 share one FD 203, and eight PDs 201 in the four pixels 107 share the FD 203. Further, the present exemplary embodiment differs from the first exemplary embodiment in that the FD 203 is connected in parallel with a plurality of SFs 206.

Reducing the size of a PD 201 for purposes, such as miniaturization, deteriorates the signal-to-noise (S/N) ratio. A plurality of PDs 201 shares one FD 203, and an electric charge generated in each PD 201 is converted into a voltage signal to improve the S/N ratio. As the number of PDs 201 sharing a single FD 203 increases, the length of the FD wire 210 increases. This may raise concerns that RTS noise increases due to the parasitic capacitance of the wiring. In the present exemplary embodiment, the FD wire 210 is disposed at a height between the height of the first wiring layer 230 and the height of the gates of the transistors. This configuration provides the effect of improving layout efficiency and reducing noise due to capacitive coupling.

FIG. 10 illustrates an example of an equivalent circuit diagram according to the present exemplary embodiment. The first photoelectric conversion portion PD 201a is connected to one FD 203 via the first transfer transistor TX 202a. The second photoelectric conversion portion PD 201b is connected to the FD 203 via the second transfer transistor TX 202b. The third photoelectric conversion portion PD 201c is connected to the FD 203 via the third transfer transistor TX 202c. The fourth photoelectric conversion portion PD 201d is connected to the FD 203 via the fourth transfer transistor TX 202d. A fifth photoelectric conversion portion PD 201e is connected to the FD 203 via a fifth transfer transistor TX 202e. A sixth photoelectric conversion portion PD 201f is connected to the FD 203 via a sixth transfer transistor TX 202f. A seventh photoelectric conversion portion PD 201g is connected to the FD 203 via a seventh transfer transistor TX 202g. An eighth photoelectric conversion portion PD 201h is connected to the FD 203 via an eighth transfer transistor TX 202h.

A DCG 204a, a DCG 204b, and a DCG 204c are connected in series between the FD 203 and the RES 205. The drain of the RES 205 and the gate of the DCG 204c are each connected to the power supply. In other words, the DCG 204c is constantly in a conducting state. The FD 203 is also connected to the gate of an SF 206a, the gate of an SF 206b, and the gate of an SF 206c. The source of the SF 206a, the source of the SF 206b, and the source of the SF 206c are each connected to the corresponding column signal line 108 via the SEL 207.

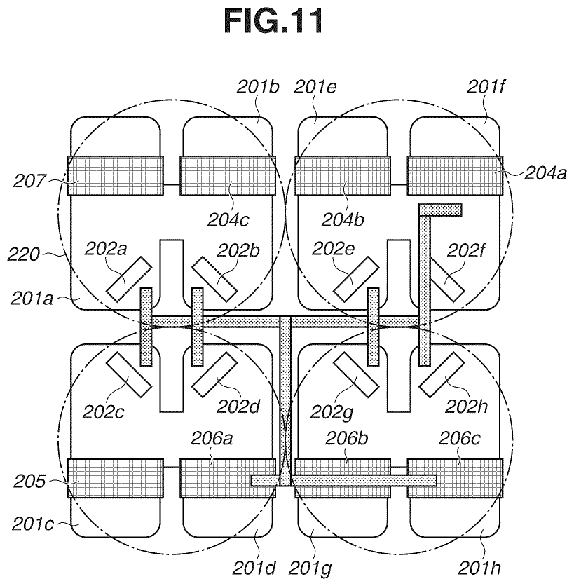

As illustrated in a plan view of FIG. 11, four pixels 107 share one FD 203 via the FD wire 210 connected to the source of the TX 202, and all PDs 201 in the four pixels 107 share the FD 203. In FIG. 11, the pixel 107 including the PD 201c and the PD 201d is provided with the RES 205 and the SF 206a, and the pixel 107 including the PD 201e and the PD 201f is provided with the DCG 204a and the DCG 204b. The pixel 107 including the PD 201a and the PD 201b is provided with the DCG 204c, and the pixel 107 including the PD 201g and the PD 201h is provided with the SF 206b and the SF 206c. In this case, combinations of the pixels 107 and the transistors to be arranged are not limited thereto, and any combination can be used as long as necessary transistors are arranged in the four pixels 107.

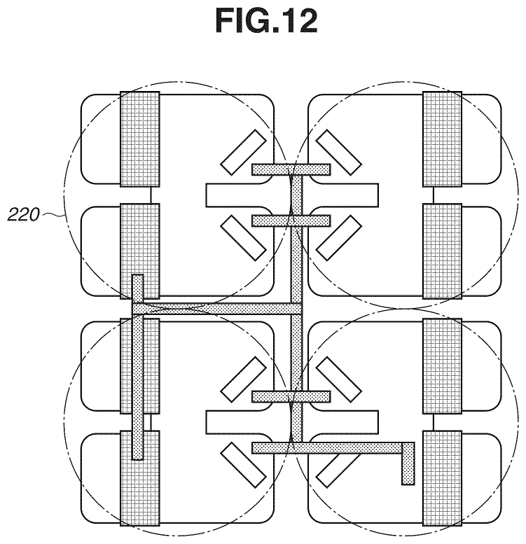

As illustrated in FIG. 12, the arrangement direction of two PDs 201 in each pixel 107 may correspond to the column direction of the pixel array 101. A plurality of types of pixels 107 with different arrangement directions of the two PDs 201 can coexist in the pixel array 101. The configuration in which a plurality of types of pixels 107 with different arrangement directions of the two PDs 201 coexists makes it possible to implement the photoelectric conversion apparatus that facilitates autofocusing on an object with a contrast in an arbitrary direction.

According to the present exemplary embodiment, the FD 203 and the FD wire 210 are connected parallel relative to the gates of a plurality of SFs 206, which makes it possible to reduce RTS noise. Further, the DCG 204 includes a plurality of transistors, making it possible to switch the conversion gain between a plurality of levels. With this configuration, the S/N ratio can be improved, and the dynamic range can be increased.

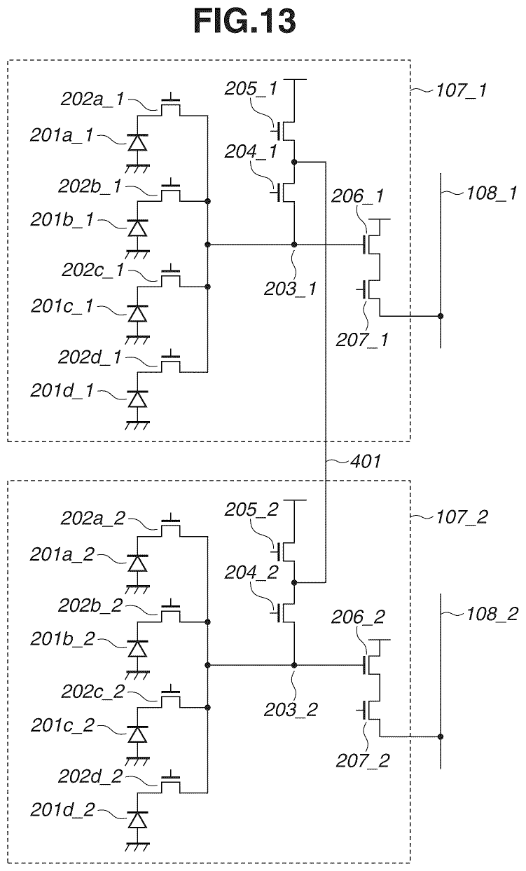

A photoelectric conversion apparatus according to a sixth exemplary embodiment will now be described with reference to FIG. 13. In the present exemplary embodiment, FDs 203 in pixels 107 arranged in different rows from each other in a pixel array 101 are connected by an inter-row FD connection wire 401.

FIG. 13 illustrates an example of an equivalent circuit diagram according to the present exemplary embodiment. In a pixel 107_1, a first photoelectric conversion portion PD 201a_1 is connected to one FD 203_1 via a first transfer transistor TX 202a_1. A second photoelectric conversion portion PD 201b_1 is connected to the FD 203_1 via a second transfer transistor TX 202b_1. A third photoelectric conversion portion PD 201c_1 is connected to the FD 203_1 via a third transfer transistor TX 202c_1. A fourth photoelectric conversion portion PD 201d_1 is connected to the FD 203_1 via a fourth transfer transistor TX 202d_1.

A DCG 204_1 is connected in series between the FD 203_1 and an RES 205_1.

The drain of the RES 205_1 is connected to the power supply. The FD 203_1 is also connected to the gate of an SF 206_1, and the source of the SF 206_1 is connected to a column signal line 108_1 via an SEL 207_1.

Similarly, in a pixel 107_2, a first photoelectric conversion portion PD 201a_2 is connected to one FD 203_2 via a first transfer transistor TX 202a_2. A second photoelectric conversion portion PD 201b_2 is connected to the FD 203_2 via a second transfer transistor TX 202b_2. A third photoelectric conversion portion PD 201c_2 is connected to the FD 203_2 via a third transfer transistor TX 202c_2. A fourth photoelectric conversion portion PD 201d_2 is connected to the FD 203_2 via a fourth transfer transistor TX 202d_2.

A DCG 204_2 is connected in series between the FD 203_2 and an RES 205_2.

The drain of the RES 205_2 is connected to the power supply. The FD 203_2 is also connected to the gate of an SF 206_2, and the source of the SF 206_2 is connected to a column signal line 108_2 via an SEL 207_2.

As illustrated in FIG. 13, a node between the RES 205_1 and the DCG 204_1 and a node between the RES 205_2 and the DCG 204_2 are connected via the inter-row FD connection wire 401. The drains of the DCG 204_1 and the DCG 204_2 are connected via the inter-row FD connection wire 401, making it possible to have a larger FD capacitance. With this configuration, a more signal electric charge can be held in the FD 203 and the dynamic range can be increased.

If the inter-row FD connection wire 401 is disposed, the number of wires increases. This imposes constraints on the wiring layout as compared with a case where the inter-row FD connection wire 401 is not disposed. However, disposing the FD wire 401 at a height between the height of the first wiring layer 230 and the height of the gates of the transistors imposes no layout constrains caused by the inter-row FD connection wire 401. The inter-row FD connection wire 401 can be disposed in the same layer as the FD wire 210. Specifically, the inter-row FD connection wire 401 can be disposed between the height of the first wiring layer 230 and the height of the gates of the transistors.

An FD wire 210 corresponding to a certain PD 201 can be disposed between the height of the first wiring layer 230 and the height of the gates of the transistors, and an FD wire 210 corresponding to another PD 201 can be disposed at the height of the first wiring layer 230. Similarly, an inter-row FD connection wire 401 corresponding to a certain pixel 107 can be disposed between the height of the first wiring layer 230 and the height of the gates of the transistors, and an inter-row FD connection wire 401 corresponding to another pixel 107 can be disposed at the height of the first wiring layer 230. In either case, the arrangement of each wire effectively reduces layout constrains.

In the present exemplary embodiment, the photoelectric conversion apparatus including the inter-row FD connection wire 401 is described, the same applies to a configuration in which the FDs 203 in the pixels 107 arranged in different pixel columns in the pixel array 101 are connected by an inter-column FD wire 402.

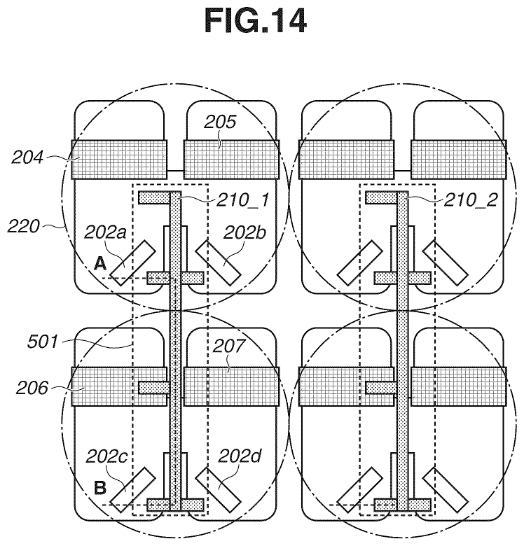

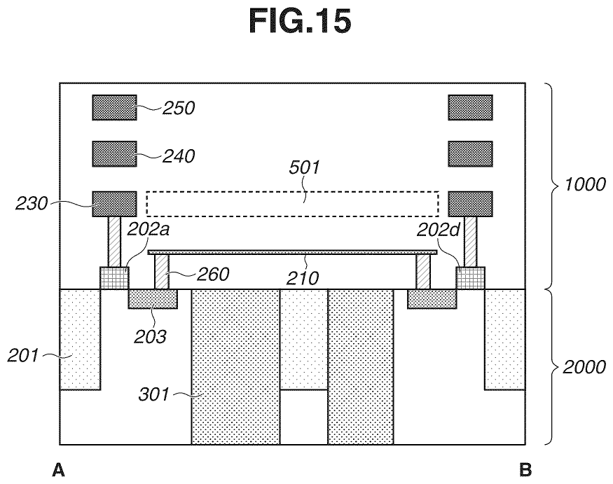

A seventh exemplary embodiment will now be described with reference to FIGS. 14 and 15. A photoelectric conversion apparatus according to the present exemplary embodiment is provided with a shield wire 501 in the vicinity of each FD wire 210 to reduce noise.

FIG. 14 is a plan view of four pixels 107 in the photoelectric conversion apparatus according to the present exemplary embodiment. In the example illustrated in FIG. 14, an FD wire 210 is disposed such that two pixels aligned in the column direction share one FD 203 and four PDs 201 share the FD 203. The shield wires 501 are each disposed on the side of the FD wire 210 closer to the first wiring layer 230 in such a manner that the shield wire 501 overlaps the FD wire 210 in a plan view and covers the FD wire 210. In FIG. 14, the outline of each shield wire 501 is indicated by a dashed line for convenience.

The FD wire 210 is capacitively coupled to surrounding wiring, and is thus affected by potential variation of the surrounding wiring. This result in noise being introduced into voltage signals based on signal electric charges to be originally output. For this reason, in the present exemplary embodiment, the shield wires 501 are each disposed to reduce noise due to capacitive coupling of the FD wire 210. This configuration can reduce the impact of potential fluctuations in other wiring on the FD wire 210 and RTS noise.

FIG. 15 is a sectional view of the photoelectric conversion apparatus according to the present exemplary embodiment. FIG. 15 is a sectional view taken along the line A-B illustrated in FIG. 14.

The shield wire 501 is disposed at the height of the first wiring layer 230 such that at least a part of the shield wire 501 overlaps the FD wire 210 in the plan view. In particular, the shield wire 501 is disposed between the FD wire 210 and a wire, such as the column signal line 108, provided in the first wiring layer 230. While FIG. 15 illustrates the example where the shield wire 501 is disposed in the same layer as the first wiring layer 230, the shield wire 501 can be disposed in a layer, such as the second wiring layer 240 or the third wiring layer 250, depending on the wiring layer in which a wire to be shielded is disposed.

For example, if the present exemplary embodiment is applied to the configuration described in the sixth exemplary embodiment, a second shield wire 501 disposed at the same height as a first FD wire 210_1 may be disposed between the first FD wire 210_1 and the second FD wire 210_2. In this case, the shield wire 501 overlapping the first FD wire 210_1 is referred to as a first shield wire.

If the shield wire 501 remains in a floating state, noise may increase. Noise can be effectively reduced by applying the source potential of the SF 206 to the shield wire 501. Thus, it may be for the shield wire 501 to be electrically connected to the source of the SF 206.

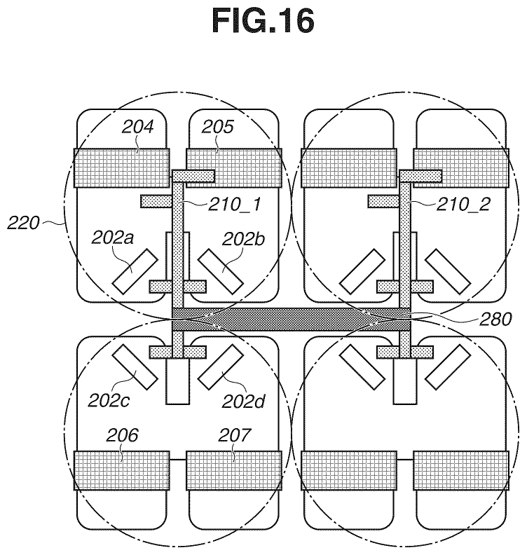

An eighth exemplary embodiment will now be described with reference to FIG. 16. A photoelectric conversion apparatus according to the present exemplary embodiment has a configuration in which the FD wires 210 each connecting the FDs 203 in a plurality of pixels 107 are connected via a wire in the first wiring layer 230.

The FDs 203 in the two pixels 107 arranged on the left among four pixels 107 illustrated in FIG. 16 are connected via the FD wire 210_1. Similarly, the FDs 203 in the two pixels arranged on the right are connected via the FD wire 210_2. Further, in the present exemplary embodiment, the FD wire 210_1 and the FD wire 210_2 are connected via an FD connection wire 280. The FD connection wire 280 is disposed in the first wiring layer 230.

In a case of connecting the FDs 203 with a single wiring layer, the wiring structure becomes more complicated as the number of the PDs 201 connecting the FDs 203 increases, which leads to decrease in layout flexibility. The FDs 203 are connected by the FD wires 210 and a wire disposed in the first wiring layer 230, making it possible to improve the layout flexibility of the wiring for the FDs to share. A switch may be disposed between each FD wire 210 and the FD connection wire 280 to control the number of the pixels 107 that share one FD 203. In this case, any one of the transistors illustrated in FIG. 16 can be used as the switch.

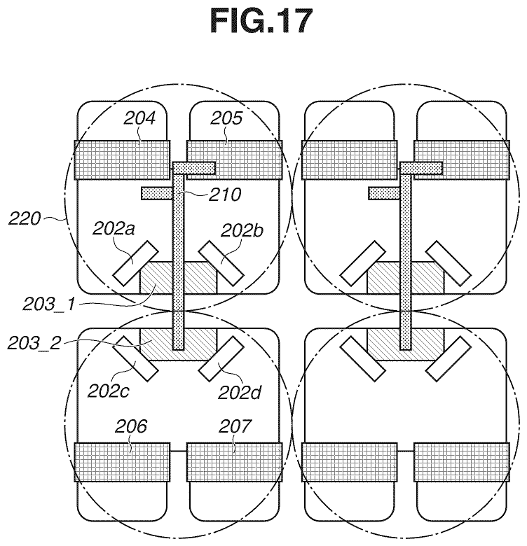

A ninth exemplary embodiment will now be described with reference to FIG. 17. In the present exemplary embodiment, a single FD 203 formed in a diffusion layer is shared by a plurality of pixels 107. In the upper-left pixel 107 among the four pixels 107 illustrated in FIG. 17, the first floating diffusion layer FD 203_1 is connected to the gates of the TX 202a and the TX 202b. Specifically, in the configuration according to the present exemplary embodiment, the FD 203 connected from the PD 201a via the TX 202a and the FD 203 connected from the PD 201b via the TX 202b are not isolated by a DTI. Similarly, in the lower-left pixel 107, the second floating diffusion layer FD 203_2 is connected to the gates of the TX 202c and the TX 202d. The configuration of the FD wire 210 connecting the FD 203_1 and the FD 203_2 is considered to constitute one FD 203. In other words, in the configuration illustrated in FIG. 8, one PD 201 is connected to the FD wire 210 via a single contact metal, whereas in the configuration illustrated in FIG. 17, two PDs 201 are connected to the FD wire 210 via a single contact metal.

Thus, a part of the FD 203 shared by the plurality of pixels 107 constitutes a diffusion layer, making it possible to shorten the length of the FD wire 210 connecting the FDs 203, reducing the parasitic capacitance of the FDs 203. In this case, the wire length includes the length of each wire disposed in the wiring layer, as well as the length of each contact to connect the wiring layers.

In the present exemplary embodiment, while the case is described where the FD 203_1 connected to one of two PDs 201 in each pixel 107 and the FD 203_2 connected to the other of the two PDs 201 are connected together, for example, four FDs 203 connected to the four PDs 201 can be connected to each other. The number of the PDs 201 to which the FDs 203 constituting diffusion layers are connected to each other, and the number of the pixels 107 are not limited to two.

A tenth exemplary embodiment will now be described. The present exemplary embodiment can be applied to any one of the first to ninth exemplary embodiments.

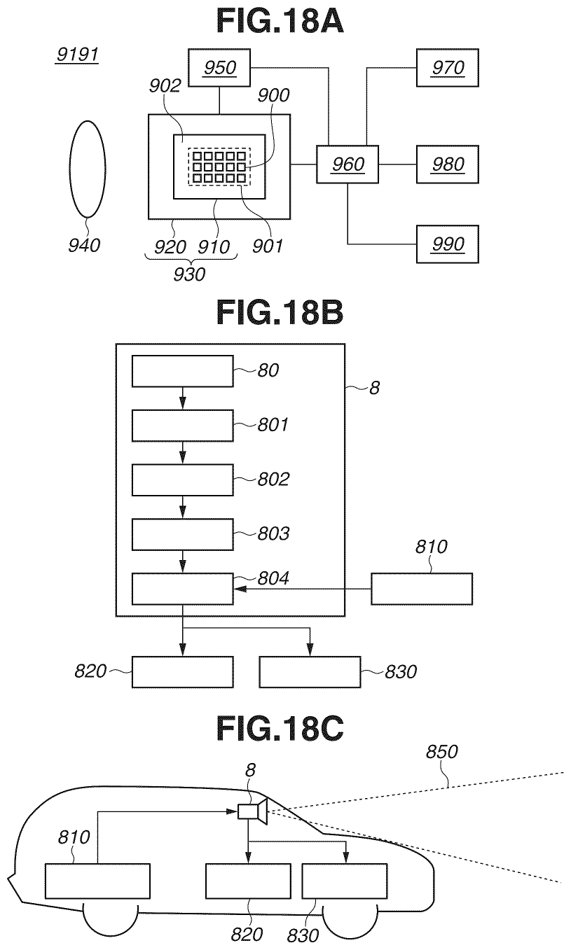

FIG. 18A is a schematic diagram illustrating equipment 9191 including a semiconductor apparatus 930 according to the present exemplary embodiment. Any one of the photoelectric conversion apparatuses according to the exemplary embodiments described above can be used as the semiconductor apparatus 930.

The equipment 9191 including the semiconductor apparatus 930 will be described in detail. The semiconductor apparatus 930 can include a semiconductor device 910, as well as a package 920 that accommodates the semiconductor device 910. The package 920 can include a base to which the semiconductor device 910 is fixed, and a lid, such as glass, that faces the semiconductor device 910. The package 920 can further include bonding members, such as bonding wiring and bumps, for connecting terminals provided on the base and terminals provided on the semiconductor device 910.

The equipment 9191 can include at least one of an optical device 940, a control device 950, a processing device 960, a display device 970, a storage device 980, and a mechanical device 990. The optical device 940 is used for the semiconductor apparatus 930. The optical device 940 is, for example, a lens, a shutter, or a mirror, and includes an optical system for guiding light to the semiconductor apparatus 930. The control device 950 controls the semiconductor apparatus 930. The control device 950 is, for example, a semiconductor device, such as an Application-Specific Integrated Circuit (ASIC).

A portion including at least one of the processing device 960, the display device 970, the storage device 980, and the mechanical device 990 is a processing unit having a function for generating images by processing signals from the semiconductor apparatus 930.

The processing device 960 processes the signals output from the semiconductor apparatus 930. The processing device 960 is a semiconductor device, such as a central processing unit (CPU) or an ASIC, for forming an analog front end (AFE) or a digital front end (DFE). The display device 970 is an electroluminescence (EL) display device or a liquid crystal display device that displays the information (i.e., the images) obtained by the semiconductor apparatus 930. The storage device 980 is a magnetic device or a semiconductor device that stores the information (i.e., the images) obtained by the semiconductor apparatus 930. The storage device 980 is a volatile memory, such as a static random-access memory (SRAM) or a dynamic RAM (DRAM), or a nonvolatile memory, such as a flash memory or a hard disk drive.

The mechanical device 990 can include a movable unit or a propulsion unit, such as a motor or an engine. In the equipment 9191, the signals output from the semiconductor apparatus 930 are displayed by the display apparatus 970 or are transmitted to an external device by a communication device (not illustrated) included in the equipment 9191. Thus, the equipment 9191 may further include the storage device 980 and the processing device 960, in addition to a storage circuit and an arithmetic circuit included in the semiconductor apparatus 930. The mechanical device 990 may be controlled based on the signals output from the semiconductor apparatus 930.

The equipment 9191 is suitable for electronic equipment, such as an information terminal (e.g., a smartphone or a wearable terminal) having an image capturing function, and a camera (e.g., an interchangeable lens camera, a compact camera, a video camera, or a monitoring camera). The mechanical device 990 in a camera is capable of driving the components of the optical device 940 to perform zooming, an in-focus operation, and a shutter operation. Alternatively, the mechanical device 990 in a camera is capable of moving the semiconductor apparatus 930 to perform an anti-vibration operation.

The equipment 9191 can be a transportation device, such as a vehicle, a vessel, or an aircraft. The mechanical device 990 in the transportation device can be used as a moving apparatus. The equipment 9191 as a transportation device is suitable for transporting the semiconductor apparatus 930 and for assisting and/or automating driving (navigating) through its image capturing function. The processing device 960 for assisting and/or automating driving (navigating) is capable of performing processing to operate the mechanical device 990 as a moving apparatus based on information obtained by the semiconductor apparatus 930. Alternatively, the equipment 9191 may be a medical device, such as an endoscope, a measurement instrument, such as a range sensor, an analytical instrument, such as an electron microscope, office equipment, such as a copying machine, or industrial equipment, such as a robot.

According to the exemplary embodiments described above, favorable pixel characteristics can be provided. Thus, the value of the semiconductor apparatus can be enhanced. Enhancing the value in this case corresponds to at least one of the following: addition of a function, improvement of performance, improvement of characteristics, improvement of reliability, improvement of manufacturing yield, reduction of environmental load, cost reduction, size reduction, and weight reduction.

Thus, use of the semiconductor apparatus 930 according to the present exemplary embodiment for the equipment 9191 makes it possible to improve the value of the equipment 9191. For example, transportation equipment provided with the semiconductor apparatus 930 can provide an excellent performance when imaging of the outside of the transportation equipment is performed or when an external environment is measured. Consequently, transportation equipment with the semiconductor apparatus 930 according to the present exemplary embodiment is advantageous for enhancing the performance of the transportation equipment itself in the manufacturing and sales of transporting equipment. In particular, the semiconductor apparatus 930 is suitable for transportation equipment that uses information obtained by the semiconductor apparatus 930 to assist in driving and/or perform automated driving.

A photoelectric conversion system and a moving body according to the present exemplary embodiment will be described with reference to FIGS. 18B and 18C.

FIG. 18B illustrates an example of a photoelectric conversion system for an in-vehicle camera. A photoelectric conversion system 8 includes a photoelectric conversion apparatus 80. The photoelectric conversion apparatus 80 is any one of the photoelectric conversion apparatuses (image capturing apparatuses) according to the exemplary embodiments described above. The photoelectric conversion system 8 includes an image processing unit 801 that performs image processing on a plurality of pieces of image data acquired by the photoelectric conversion apparatus 80, and a parallax acquisition unit 802 that calculates a parallax (a difference in phase between parallax images) based on the plurality of pieces of image data acquired by the photoelectric conversion system 8. The photoelectric conversion system 8 includes a distance acquisition unit 803 that calculates a distance to a target object based on the calculated parallax, and a collision determination unit 804 that determines whether a possibility of collision exists based on the calculated distance. The parallax acquisition unit 802 and the distance acquisition unit 803 are examples of a distance information acquisition unit that acquires distance information indicating a distance to a target object. Specific examples of the distance information include information about a parallax, a defocusing amount, and a distance to a target object. The collision determination unit 804 can use any one of these pieces of information to determine whether a possibility of collision exists. The distance information acquisition unit can be implemented by exclusively designed hardware or can be implemented by a software module. Further, the distance information acquisition unit can be implemented by a field programmable gate array (FPGA), an ASIC, and the like, or can be implemented by a combination of the above-described components.

The photoelectric conversion system 8 is connected to a vehicle information acquisition device 810 and is capable of acquiring vehicle information indicating a vehicle speed, a yaw rate, a steering angle, and other information about the vehicle. The photoelectric conversion system 8 is connected to a control electronic control unit (ECU) 820 serving as a control unit that outputs, based on a determination result from the collision determination unit 804, a control signal to generate braking force for the vehicle. The photoelectric conversion system 8 is also connected to an alarm device 830 that issues an alarm to a driver based on the determination result from the collision determination unit 804. For example, if a high possibility of collision exists as a result of determination by the collision determination unit 804, the control ECU 820 controls the vehicle to avoid the collision or reduce damage by, for example, applying the brake, releasing the accelerator, or reducing the engine output. The alarm device 830 warns the user by, for example, sounding an alarm, displaying alarm information on a screen of a car navigation system or the like, or vibrating the seatbelt or the steering wheel.

In the present exemplary embodiment, the photoelectric conversion system 8 captures images of the vicinity of the vehicle, such as in front of or behind the vehicle.

FIG. 18C illustrates a configuration example of the photoelectric conversion system 8 where images of a scene in front of the vehicle (an image capturing range 850) is captured. The vehicle information acquisition device 810 transmits instructions to the photoelectric conversion system 8 or the photoelectric conversion apparatus 80. This configuration makes it possible to improve accuracy in distance measurement.

The example is described above of control for avoiding collisions with other vehicles. However, the control can be applied to, for example, control for automated driving that follows other vehicles or control for automated driving that prevents lane departure. The photoelectric conversion system can be applied to vehicles, such as automobiles, as well as moving bodies (moving apparatuses), such as vessels, aircrafts, or industrial robots. In addition to the moving bodies, the photoelectric conversion system can be applied to a wide range of equipment using object recognition, such as an intelligent transportation system (ITS).

The above-described exemplary embodiments can be modified as appropriate without departing from the technical idea of the present invention. The disclosed content of the present specification encompasses what is described in the present specification, as well as all matters that can be recognized from the present specification and the drawings attached to the present specification. The disclosed content of the present specification includes complementary sets of concepts described in the present specification. Thus, if the present specification states, for example, “A is larger than B”, it can be said that the present specification also discloses that “A is not larger than B” even if the description “A is not larger than B” is omitted. This is because the description “A is larger than B” is based on the premise that the case where “A is not larger than B”.

According to the present invention, wiring layout flexibility can be improved while the parasitic capacitance of FD is reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-095706, filed Jun. 13, 2024, which is hereby incorporated by reference herein in its entirety.

What is claimed is:

1. A photoelectric conversion apparatus comprising:
a substrate including:
a first photoelectric conversion portion;
a second photoelectric conversion portion;
a first floating diffusion layer to which an electric charge generated in the first photoelectric conversion portion is transferred; and
a second floating diffusion layer to which an electric charge generated in the second photoelectric conversion portion is transferred;
a transfer transistor configured to transfer the electric charge generated in the first photoelectric conversion portion to the first floating diffusion layer; and
a plurality of wiring layers stacked on a surface of the substrate,
wherein the photoelectric conversion apparatus includes first wiring connecting the first floating diffusion layer and the second floating diffusion layer to each other at a height between a height of the surface and a height of a wiring layer closest to the substrate of the plurality of wiring layers, and
wherein a first distance between the surface and an upper surface of the first wiring is different from a second distance between the surface and an upper surface of a gate electrode of the transfer transistor.

2. The photoelectric conversion apparatus according to claim 1,
wherein the substrate further includes a plurality of pixels including a first pixel and a second pixel, and
wherein the first pixel includes the first photoelectric conversion portion, and the second pixel includes the second photoelectric conversion portion.

3. The photoelectric conversion apparatus according to claim 2, wherein the first pixel includes a plurality of photoelectric conversion portions including the first photoelectric conversion portion, and the second pixel includes a plurality of photoelectric conversion portions including the second photoelectric conversion portion.

4. The photoelectric conversion apparatus according to claim 1, wherein the substrate further includes:
a third photoelectric conversion portion;
a fourth photoelectric conversion portion;
a third floating diffusion layer to which an electric charge generated in the third photoelectric conversion portion is transferred; and
a fourth floating diffusion layer to which an electric charge generated in the fourth photoelectric conversion portion is transferred.

5. The photoelectric conversion apparatus according to claim 4, wherein the first floating diffusion layer, the second floating diffusion layer, the third floating diffusion layer, and the fourth floating diffusion layer are connected to each other by the first wiring.

6. The photoelectric conversion apparatus according to claim 1, wherein the first floating diffusion layer and the second floating diffusion layer are connected to a common floating diffusion layer.

7. The photoelectric conversion apparatus according to claim 4, wherein the third floating diffusion layer and the fourth floating diffusion layer are connected to a common floating diffusion layer.

8. The photoelectric conversion apparatus according to claim 1, wherein the first floating diffusion layer and the second floating diffusion layer are connected via a part of the first wiring and the wiring layer closest to the substrate.

9. The photoelectric conversion apparatus according to claim 4, wherein the third floating diffusion layer and the fourth floating diffusion layer are connected via the first wiring and a part of the wiring layer closest to the substrate.

10. The photoelectric conversion apparatus according to claim 1, wherein the wiring layer closest to the substrate includes first shield wiring overlapping the first wiring in a plan view.

11. The photoelectric conversion apparatus according to claim 10, wherein the first shield wiring is electrically connected to a source of a source follower transistor connected to the transfer transistor.

12. The photoelectric conversion apparatus according to claim 4, further comprising:
second wiring disposed at a height between the height of the surface and the height of the wiring layer closest to the substrate and connecting the third floating diffusion layer and the fourth floating diffusion layer to each other; and
second shield wiring disposed at the same height as the height of the first wiring between the first wiring and the second wiring.

13. The photoelectric conversion apparatus according to claim 1, wherein an isolation portion penetrating through the substrate is disposed between the first photoelectric conversion portion and the second photoelectric conversion portion, and the isolation portion isolates the first floating diffusion layer from the second floating diffusion layer.

14. The photoelectric conversion apparatus according to claim 1, further comprising a reset transistor connected to the first photoelectric conversion portion, a source of the reset transistor being connected to the first wiring.

15. The photoelectric conversion apparatus according to claim 1, wherein the first distance is longer than the second distance.

16. A photoelectric conversion system comprising:
the photoelectric conversion apparatus according to claim 1; and
a processing unit configured to generate an image using a signal output from the photoelectric conversion apparatus.

17. A moving body comprising:
the photoelectric conversion apparatus according to claim 1; and
a control unit configured to control movement of the moving body using a signal output from the photoelectric conversion apparatus.

18. A photoelectric conversion apparatus comprising:
a substrate including:
a first photoelectric conversion portion;
a second photoelectric conversion portion;
a first floating diffusion layer to which an electric charge generated in the first photoelectric conversion portion is transferred; and
a second floating diffusion layer to which an electric charge generated in the second photoelectric conversion portion is transferred;
a plurality of wiring layers stacked on a surface of the substrate; and
an insulating layer disposed on the surface,
wherein the photoelectric conversion apparatus includes a first wiring connecting the first floating diffusion layer and the second floating diffusion layer to each other at a height between a height of the surface and a height of a wiring layer closest to the substrate of the plurality of wiring layers, and
wherein the insulating layer is disposed between the surface and the first wiring.

19. The photoelectric conversion apparatus according to claim 18, wherein the wiring layer closest to the substrate includes first shield wiring overlapping the first wiring in a plan view.

20. A photoelectric conversion system comprising:
the photoelectric conversion apparatus according to claim 18; and
a processing unit configured to generate an image using a signal output from the photoelectric conversion apparatus.
